(19) United States
(12) Patent Application Publication
(10) Pub. No.: US 2023/0063669 A1
(43) Pub. Date: Mar. 2, 2023

(54) Metal Powder for an Additive Manufacturing Process, Uses of the Metal Powder, Method for Producing a Component, and Component

(71) Applicant: Deutsche Edelstahlwerke Specialty Steel GmbH & Co. KG, Witten (DE)

(72) Inventors: Andreas Mohr, Essen (DE); Horst Hill, Grefrath (DE); Janosch Conrads, Gladbeck (DE); Karlheinz P. J. Hoeren, Krefeld (DE)

(21) Appl. No.: 17/793,809

(22) PCT Filed: Jan. 19, 2021
(86) PCT No.: PCT/EP2021/051066

§ 371 Date: Jul. 19, 2022

(30) Foreign Application Priority Data
Jan. 20, 2020 (EP) 20152725.6

(51) Int. Cl. C22C 38/44; B22F 10/28; B22F 10/64; B22F 10/66; B22F 9/08; C22C 38/04; C22C 38/02; C22C 38/00; B33Y 40/20; B33Y 10/00; B33Y 70/00

(52) U.S. Cl. CPC C22C 38/44; B22F 10/28; B22F 10/64; B22F 10/66; B22F 9/082; C22C 38/04; C22C 38/02; C22C 38/001; B33Y 40/20; B33Y 10/00; B33Y 70/00; B22F 2009/0848; B22F 2301/35

(57) ABSTRACT

The invention relates to a metal powder intended for use in an additive manufacturing process, which consists of steel particles having an average diameter of 5-150 μm and consisting of, in mass %, C: 0.15-1.0%, N: 0.15-1.0%, Si, 0.1-2.0%, Mn: 10-25%, Cr: 5-21%, Mo: 0.1-3.0%, Ni: ≤5%, remainder of iron and unavoidable impurities. The metal powder has a flow rate determined in accordance with DIN EN ISO 4490 of less than 30 sec/50 g. Using a metal powder according to the invention, reliable high-load-bearing components can be produced by additive manufacturing. Accordingly, a metal powder according to the invention is particularly suitable for the manufacture of machine elements that are exposed to high loads and of medical components that are used in or on the human or animal body. The invention also provides a method which reliably allows components with optimised mechanical properties to be manufactured from metal powder according to the invention on the basis of an additive manufacturing process.

### CROSS-REFERENCE TO RELATED APPLICATIONS

This application is the United States national phase of International Application No. PCT/EP2021/051066 filed Jan. 19, 2021, and claims priority to European Patent Application No. 20152725.6 filed Jan. 20, 2020, the disclosures of which are hereby incorporated by reference in their entirety.

### BACKGROUND OF THE INVENTION

### Field of the Invention

The invention relates to a metal powder for use in an additive manufacturing process and consists of steel particles. The invention also relates to uses of such a metal powder, a method in which a component is manufactured from such a metal powder using an additive manufacturing process and a component which is manufactured using an additive manufacturing process.

### Description of Related Art

If “%” information for alloys or steel compositions is given in the following, it refers respectively to the mass (information in “mass”), unless explicitly stated otherwise.

The proportions of certain constituents of the structure of an intermediate steel product or a steel component are indicated in this text in volume %, unless expressly stated otherwise. The proportions of the constituents of the structure are determined by means of X-ray diffractometry, wherein the evaluation of the structure proportions is carried out according to the Rietveld method.

All of the mechanical properties indicated in this text, tensile strength Rm, yield strength Rp, elongation at break A5.65 are determined in accordance with DIN 50125, unless otherwise indicated.

The values for notch impact energy and notch impact strength indicated in this text are determined in accordance with DIN EN 10045.

Austenitic stainless steels have a wide range of applications within traditional mechanical engineering and medical technology, in particular due to their good deformability and very good corrosion properties. An important representative of these steels is the steel X2CrNiMo17-12-2 standardised in the steel iron list under material number 1.4404, which consists of, in accordance with DIN EN 10088-3, in mass %, up to 0.03% C, up to 1.00% Si, up to 2.00% Mn, 16.5%-18.5% Cr, 2.0-2.5% Mo and 10.0-13.0% Ni, the remainder iron and unavoidable impurities.

The alloy concept, which is based on stainless austenitic steels, must guarantee the corrosion resistance of the material. This is achieved in particular by adding chromium (“Cr”). At contents of more than 12 mass % Cr, a chromium oxide layer forms on the component formed from the steel, which prevents corrosion reactions. This chromium oxide layer can be further stabilised by the element molybdenum (“Mo”). The presence of Mo in the steel alloy in particular leads to increased resistance to pitting corrosion.

However, Cr and Mo can only contribute to corrosion resistance if both elements are dissolved in the metal matrix. For this reason, the carbon content (“C”) of stainless austenitic steels is limited to at most 0.030 mass % and the nitrogen content (“N”) to at most 0.011 mass %. Otherwise there would be a risk of chromium carbides or chromium nitrides forming, which would lead to local impoverishment of the steel's metal matrix.

Chromium carbides preferably precipitate along grain boundaries, which is in practice critical for technical application. This process leads to intergranular corrosion, which in technical applications usually leads to complete failure of the component made from the respective steel, as explained in “Ferrous materials—Steel and cast iron”, H. Berns, W. Theisen, DOI: 10.1007/978-3-540-79957-3, Springer Verlag.

However, carbon cannot be generally classified as a critical element in stainless austenites. C and N can also be used as interstitial elements to increase the properties of austenites. In this way, these elements can also contribute to corrosion resistance when dissolved. This contribution can be estimated using what is known as the MARC equation

MARC=[% Cr]+3.3*[% Mo]+20*[% C]−0.5*[% Mn]−0.25*[% Ni]

(MARC=measure of alloying for resistance to corrosion), which takes into account the effects of the elements having a positive effect (Cr, Mo, N, C) and negative effect (manganese (“Mn”), nickel (“Ni”)) on corrosion resistance.

In addition, C and N, as substituted elements, increase the strength of austenitic steels by solid solution strengthening. What are known as “C+N alloyed stainless austenitic steels”, which have a high proportion of interstitially dissolved atoms, apply to this effect. An example of an alloy regulation of such a steel has been published in DE 101 46 616 A1. It stipulates that a stainless austenitic steel consists of, in mass %, 12-15% Cr, 17-21% Mn, <0.7% Si, in total 0.4-0.7% C and N, and as the remainder of iron and manufacture-related unavoidable impurities, the total content of which is limited to less than 1.0%. The following applies to the ratio % C:% N formed from the respective C content % C and the respective N content % N: 0.6<% C:% N<1.0. In the solution-annealed state, steels composed in such a way have significantly higher strengths than the conventional stainless austenitic steels, to which the aforementioned steel with the material number 1.4404 belongs to.

The advantages of the improved mechanical properties of C+N-alloyed, stainless austenitic steels are offset by the low solubility of N in molten iron (“Fe”), which makes it difficult to alloy N. One way to still generate steels with a higher N content is by what is known as “pressure nitriding the melt”. Pressure nitriding, in turn, requires special furnace technologies that allow the steel to melt under a pressure at which the required amount of nitrogen is dissolved in the melt (see for example EP 1 196 642 B1).

By adding Mn, the N solubility of a melt can be increased. Higher Mn contents therefore enable the manufacture of steels with high N contents under atmospheric pressure. In addition, both Mn and N are strong austenite stabilisers, whereby in steels with high Mn and N contents, the expensive alloying element nickel (“Ni”) is no longer required or is only required to a limited extent as an austenite stabiliser.

Thus, C+N-alloyed austenitic steels have the following advantages compared to conventional stainless austenitic steels, where only minimised contents of N and C are provided:
Higher strength due to a high proportion of the interstitially dissolved atoms C and N (solid solution hardening).
Higher tendency for work hardening of the alloys due to the interstitially dissolved atoms.
Higher corrosion resistance due to a high proportion of the interstitially dissolved atoms C and N.
Lower alloy costs due to the substitution of Ni with Mn.
Possibility for application in the field of medical technology due to the substitution of Ni with Mn (avoidance of nickel allergies).

The attempts to use the aforementioned C+N alloyed austenitic steels industrially on the conventional melt metallurgical production route are contrasted by the fact that the cooling of cast precursors cast from such steels, such as blocks, slabs or the like, inevitably produce chromium carbides in the respective cast precursor, which also have an unfavourable effect on corrosion resistance here. However, to ensure sufficient corrosion resistance, the steels must undergo solution annealing during their processing to dissolve the chromium carbides. However, the annealing temperatures required for this are above 1100° C. and can only be achieved in practice by means of special heat treatment furnaces. Another problem with the conventional manufacturing route is that thick cross-sections in particular cannot be cooled sufficiently quickly to prevent the formation of chromium carbide again.

In addition, austenitic steels with high C+N contents are difficult or impossible to form or machine at room temperature due to a strong tendency for work hardening. Instead, they must be hot-formed, whereby the temperatures required for this are in turn so high that the cooling of the respectively hot-formed component can again lead to the formation of undesired chromium carbides. This severely restricts the processing temperatures possible for hot forming and the possible degrees of deformation with which the steels can be hot-formed. In addition, hot forming eliminates the possibility of optimising the mechanical properties of C+N-alloyed austenitic steels through work hardening. This means that a great deal of reworking is required, in particular in the manufacture of filigree-shaped components, or that components cannot be manufactured from such steels whose strength is subject to special requirements.

An alternative to the conventional molten metallurgical manufacture route is powder metallurgy, which is used to produce components close to the end contour by, for example, pressing metal powder into the desired shape and then compressing it by means of a sintering process. First and foremost, water-atomised metal powders are used for this purpose, since they can be easily compressed into a raw component due to the angular shape of the powder particles, which is characterised by protruding indents and the like, and thus make possible the required dimensional stability of the raw component without additional aids.

In addition, for example, in the publication “Characterization of the surface of Fe-19Mn-18Cr—C—N during heat treatment in a high vacuum—An XPS study”, K. Zusmande et al, Materials Characterization, Vol. 71 (2012), 66-76, it has been demonstrated that manganese oxides may be present on the particle surface of gas-atomised powders. These manganese oxides act like a diffusion barrier and lead to the metal powders containing such MnO oxides on the surface of their powder particles being unusable for conventional sintering.

Hot isostatic pressing (“HIP”) is another possibility of compressing metal powders consisting of an austenitic steel of the type in question alloyed with C+N. This method makes it possible to compact the metal powder up to the theoretical density despite oxide coatings. However, studies reported, for example, in the publication “Surface Oxide Transformation during HIP of Austenitic Fe-19Mn-18Cr—C—N PM steel”, E. Hryha et al, Proceedings of 11-th International Conference on Hot Isostatic Pressing, 9-13 June 2014, Stockholm, Sweden, have shown that the oxide coatings of the powder particles have a negative effect on the mechanical properties, in particular the toughness, of a component produced from such metal powders even if the metal powder has been compressed by hot isostatic pressing. Another disadvantage of hot isostatic pressing is that complexly formed capsules are required for manufacture close to the end contour in which the metal powder is pressed. This restricts the possibility for technically and economically sensible use of hot isostatic pressing. Similarly, the forming of the component taking place in a capsule during hot isostatic pressing results in low cooling rates, so that undesired chromium carbides can in turn occur in the component during cooling after hot isostatic pressing. These would have to be dissolved again by a downstream heat treatment, such that the same problems occur here as with the conventional production explained above.

The above-mentioned disadvantages of the known processes for the manufacture of components close to the end contour can be avoided by additive manufacturing processes.

The term “additive manufacturing process” here summarises all manufacturing processes in which a material is added to produce a component. This addition usually takes place in layers. “Additive manufacturing processes”, which are often referred to in the technical language as “generative processes” or generally as “3D printing”, thus stand in contrast to the classic subtractive manufacturing processes, such as the machining processes (for example, milling, drilling, and turning), in which material is removed in order to give shape to the component to be respectively produced. Likewise, additive processes generally differ from conventional solid forming processes, such as forging and the like, in which the respective steel part is formed while retaining the mass of a starting or intermediate product.

The additive manufacturing principle makes it possible to manufacture geometrically complex structures that cannot be realised or can only be realised with great difficulty using conventional manufacturing processes, such as the aforementioned machining processes or primary shaping processes (casting, forging) (see VDI Status Report “Additive Manufacturing Methods”, September 2014, published by Verein Deutscher Ingenieure e.V., Fachbereich Produktionstechnik and Fertigungsverfahren (Association of German Engineers, Department of Production Technology and Manufacturing Processes), www.vdi.de/statusadditiv).

Further definitions of the methods summarised under the generic term “additive methods” can be found, for example, in VDI Guidelines 3404 and 3405.

In the additive processing of metal powders into components, a distinction is made between methods in which the solidification of the metal powder takes place by means of heat input, by means of which the metal particles of the powder are melted in such a way that they form materially bonded compounds, and methods in which the solidification is achieved by means of a binder, which is mixed with the powder particles, so that the particles are held in a solid matrix after hardening.

Due to the short exposure times of the heat source, the additive manufacturing processes based on heat input enable cooling rates that are so high that no chromium carbides develop in the component produced. Austenitic steel materials of the type in question here are particularly suitable for additive manufacturing due to the fact that they do not undergo any phase transformation during heating and cooling. For this reason, the steel X2CrNiMo17-12-2 (material number 1.4404) mentioned at the outset has, inter alia, established itself as one of the standard steels for the production of metal powders for 3D printing. However, when printed, this steel achieves mechanical properties at room temperature that are inadequate for many applications.

Against the background of the prior art explained above, the object has been to provide a metal powder suitable for additive manufacturing, which enables the reliable production of high-load-bearing components.

In addition, advantageous uses of the metal powder to be provided should be indicated.

A method should also be proposed which enables the reliable production of components with optimised mechanical properties based on an additive manufacturing process with the metal powders to be provided.

Finally, a component should be indicated which, when manufactured by an additive manufacturing process, exhibits optimised mechanical properties.

### SUMMARY OF THE INVENTION

A metal powder achieving this object has at least the features as described herein according to the invention.

According to the invention, a method achieving the above-mentioned object comprises at least the work steps as described herein. It goes without saying that a person skilled in the art, in carrying out the method according to the invention and its variants and expansion options explained here, supplements the work steps not explicitly mentioned in the present case, which he knows from his practical experience are regularly applied when carrying out such methods.

Finally, the object mentioned above is also achieved according to the invention by a component which has at least the features as described herein and is manufactured by an additive manufacturing process.

In particular, such a component according to the invention can be manufactured from metal powder obtained according to the invention by applying the method according to the invention.

In particular, the components according to the invention are machine elements exposed to high stress in practice or components for use in or on the human or animal body by an additive manufacturing process for the manufacture of which a metal powder according to the invention is particularly suitable.

Further advantageous embodiments of the invention are defined in the dependent claims and, like the general concept of the invention, are explained in detail in the following.

The term “component for use in or on the human or animal body” here includes implants that are permanently installed in the body, such as screws, rails, braces, parts of hip or knee joints, tooth pillars or other tooth implants firmly anchored in the jaw and other parts implanted as replacements for natural bones or joints, as well as prostheses that are temporarily or permanently fastened to the body, such as parts of dental prosthetics (bridges, tooth part or full replacement) or tools that are required in particular in the treatment of dental or general surgery. Materials for implants or prostheses must be sufficiently corrosion-resistant and have optimised biocompatibility. Consequently, they must not, during use, have any harmful effects on the body in which or on which the components manufactured from them are used, nor must they trigger any other reactions that could have an unfavourable effect on well-being or health. At the same time, implant or prosthesis materials must have a mechanical property sufficient for the respective intended use, such as strength, toughness and the like. A metal powder, the particles of which are composed in the above-mentioned manner within the framework of the alloy specified according to the invention, optimally fulfils this requirement profile and also enables filigree, yet stable, components to be manufactured through the use of known 3D printing processes, which can safely withstand the stresses occurring during their use in the body. Thus, for example, components for general surgical and dental surgical purposes, such as screws, nails, bolts, parts for joints and the like, but also surgical instruments, such as operating instruments and the like, can be manufactured from metal powder according to the invention by additive manufacturing.

At the same time, the metal powder according to the invention is suitable for producing highly-loadable and at the same time highly corrosion-resistant machine elements, such as pump housings or other filigreely formed machine components, the shaping of which, for example, is subject to particular requirements due to special flow engineering requirements and which cannot be represented with conventional forming, reshaping or subtractive manufacturing methods. Here, in particular, the strong tendency for work hardening of the steel material used according to the invention can be used to manufacture components which, despite minimised dimensions, in practice can withstand high compressive stresses and the like.

Accordingly, a metal powder provided according to the invention for use in an additive manufacturing process consists of steel particles which
have an average diameter of 5-150 μm

and
consist of, in mass %,
   C: 0.15-1.0%,
   N: 0.15-1.0%,
   Si: 0.1-2.0%,
   Mn: 10-25%,
   Cr: 5-21%,
   Mo: 0.1-3.0%,
   Ni: ≤5%,
   with the remainder being iron and unavoidable impurities,
wherein the metal powder has a flow rate determined in accordance with DIN EN ISO 4490 of less than 30 sec/50 g.

As already explained at the beginning, the high contents of carbon (“C”) and nitrogen (“N”) of the steel particles of a metal powder according to the invention contribute to the strength, work hardening and corrosion resistance of the components, which are produced from metal powder according to the invention by additive manufacturing. In order to ensure this, the invention provides for C and N contents, which can amount to 0.3-2 mass % in total, wherein the C content and the N content are respectively 0.15-1 mass %. In terms of strength properties and processing behaviour as well as corrosion resistance, contents of C or N of at least 0.3 mass % have proven to be particularly advantageous in practice, wherein C or N contents of the steel particles of the metal powder of at most 0.7 mass % ensure a particularly advantageous combination of high strength values, good toughness properties and equally good elongation at break. In total, the contents of C and N of the steel particles of a metal powder according to the invention are advantageously limited to 0.6-1.4 mass %.

The melt from which the steel particles of a metal powder according to the invention are produced, and thus the steel particles themselves, contain 0.1-2 mass % silicon (“Si”), in order to adjust the melting point and the viscosity of the melt during the atomisation of the melt into the steel particles in such a way that the melt can be atomised in a reliable manner into the steel particles. Si is also required for the deoxidisation of the melt during steel production. Si contents of at least 0.15 mass % are particularly suitable, wherein the positive influences of the presence of Si can be used particularly effectively if the Si content is at most 0.6 mass %.

Manganese (“Mn”) is contained in the steel particles of a metal powder according to the invention in contents of 10-25 mass % in order to ensure that the structure of a component produced from metal powder according to the invention consists at least predominantly, preferably completely in the technical sense, of austenite. The contents of manganese are thereby set in such a way that the austenitic phase of the structure is not only stabilised by the combined presence of C, N and Mn such that sufficient austenite proportions are present in the structure even in the solidified state of the component, but at the same time the ferrite-stabilising effect of the contents of chromium (“Cr”) , molybdenum (“Mo”) and silicon (Si) also provided according to the invention in the alloy of the steel particles of the metal powder is compensated. Mn is also required to increase the nitrogen solubility of the melt. In this way, the high N contents provided according to the invention can be achieved under atmospheric pressure.

It is essential here that, according to the invention, the Mn contents of the steel particles of a metal powder according to the invention are dimensioned such that, despite the fact that during the production of the metal powder and the additive manufacturing, a part of the Mn content present in the steel of the steel particles is lost, an austenite content is still present in the component obtained by the additive manufacturing, which is sufficient to form the desired predominantly, in particular completely austenitic structure. In this case, the invention is based on the knowledge that there is a loss of 0.5-2.5 mass % Mn in the course of additive manufacturing, wherein practical tests have shown that the occurring Mn losses are regularly 1.5±0.5 mass %.

In order to ensure that the structure of a component produced from metal powder according to the invention is completely austenitic in the technical sense and therefore the component in question is reliably non-magnetic, the Mn content of the metal powder can be set, taking into account the Mn loss occurring via additive manufacturing, such that more than 10 mass %, in particular more than 13 mass %, of Mn are reliably present in the component obtained. Practical tests have shown here that in the case of Mn contents of the steel particles of a metal powder according to the invention of at least 13 mass %, in particular at least 15 mass %, an Mn content is reliably present in the component produced by additive manufacturing from a metal powder according to the invention, which guarantees a completely austenitic structure. Mn contents of at least 15 mass % are therefore also provided in particular for the steel particles of a metal powder according to the invention if components are to be produced from the metal powder by additive manufacturing for use in the human or animal body.

According to the invention, a structure is regarded as “completely austenitic”, in which the total of the proportions of the structural constituents, which are technically unavoidable in addition to austenite in the structure of the component, is at most 10 vol. %. In this case, the proportions of the other structural constituents are preferably to be kept as low as possible, so that they are particularly preferably less than 5 vol. %.

The content of chromium (“Cr”) of the steel particles of a metal powder according to the invention is 5-21 mass % in order to ensure, in combination with a content of molybdenum (“Mo”) of 0.5-3.0 mass %, sufficient corrosion resistance of the component formed from the metal powder according to the invention by the respective additive manufacturing process. If sufficient corrosion resistance is to be ensured for the manufacture of components to be used in human or animal bodies or in other highly corrosive environments, Cr contents of at least 14 mass % in the steel particles of the metal powder can be provided for this purpose.

Nickel (“Ni”) can be provided in the steel particles of a metal powder according to the invention in contents of up to 5 mass % if machine elements are to be manufactured from the metal powder, the toughness of which is subject to particular requirements. However, if a component to be used on or in the human or animal body is to be manufactured from metal powder according to the invention, the Ni content should be set as low as possible, but in any case limited to at most 0.1 mass %, so that despite the technically unavoidable presence of Ni due to the manufacturing process, the components manufactured from the metal powder according to the invention do not trigger an allergic reaction if they come into contact with a human or animal body.

Impurities of the steel particles of a metal powder according to the invention include all alloy elements not explicitly mentioned here, which inevitably enter the steel during steel production and processing, but whose contents are in any case so low that they have no influence on the properties of a steel alloyed in the manner according to the invention. Naturally, the levels of impurities should therefore be kept as low as possible. However, for technical and economic reasons in total up to 2 mass %, preferably up to 1 mass %, particularly preferably less than 1 mass % of impurities in the steel of the steel particles of a metal powder according to the invention are approved as harmless with regard to the effects and properties sought according to the invention. In the event that the metal powder according to the invention is intended for the manufacture of components for use on the human or animal body, in addition to the contents of Ni, the total of the contents of cadmium (“Cd”), beryllium (“Be”) and lead (“Pb”) attributable to the undesired impurities should also be limited to at most 0.02 mass %.

Due to the proviso that a metal powder according to the invention must have a flow rate of less than 30 sec/50 g determined according to DIN EN ISO 4490, the metal powder has a flowability which makes it optimally suitable for conventional 3D printing processes. This applies in particular if the flow rate is at most 20 sec/50 g.

The bulk density of a metal powder according to the invention should be at least 3 g/cm³ in order to ensure optimum workability. Bulk densities that are particularly suitable for practice are in the range of 3-6 g/cm³.

In accordance with the above explanations of the invention, a method according to the invention for manufacturing a steel component comprises the following steps:
a) melting a steel melt, which consists of, in mass %,
   C: 0.15-1.0%,
   N: 0.15-1.0%,
   Si: 0.1-2.0%,
   Cr: 5-21%,
   Mo: 0.1-3.0%,
   Ni: ≤5%,
   and of Mn
   and as the remainder of iron and manufacture-related unavoidable impurities, wherein the Mn content of the melt is 0.5-5% higher than the respective Mn target content % Mn_Z of the component to be manufactured, for which the following applies: 8%≤Mn_Z≤24%.
b) atomising the melt melted in work step a) into a metal powder, wherein the steel particles obtained with an average grain size of 5-150 μm are selected for further processing;
c) manufacturing the component using an additive manufacturing process in which
   c.1) at least one solidified volume section of the component to be manufactured is produced from at least one portion of the metal powder;
   c.2) if necessary, a further portion of the metal powder is applied to the volume section solidified in work step c.1
   and
   c.3) if necessary, work steps c.1 and c.2 are repeated until the component to be manufactured is additively formed in a completely finished manner;
d) optional machining to shape the components;
e) optional final heat treatment of the component obtained;
f) optional mechanical or thermochemical edge layer treatment of the component.

The method according to the invention specifies for the Mn content of the melt, which is to be atomised into the metal powder according to the invention, that the Mn content of the melt should be 2-4 mass % higher than the Mn content, which is to be present in the component produced according to the invention, so that the desired mechanical properties and the equally desired, at least predominantly austenitic structure are present in this component.

In this case, the invention is based on the knowledge that not only in the course of the additive manufacturing process used in each case, as already mentioned, but also in the atomising of the melt into the metal powder, there are significant losses of Mn. In practice, these are also regularly in the range of 1.5±0.5 mass %. By overalloying according to the invention the melt with a sufficient content of Mn compared to the alloy of the finished component produced according to the invention, all Mn losses that can occur through the production and processing of a metal powder according to the invention are thus proactively compensated.

The steel particles of the metal powder are produced by a suitable atomisation process in a conventional manner, for example by gas or water atomising. If necessary, the powder particles having a suitable grain size are selected for further processing according to the invention from the obtained powder particles by way of sieving. Here, grains having an average diameter of 5-150 μm have proven to be suitable for the purposes according to the invention. The grains selected according to the invention by sieving and, if necessary, additional air separation thus have a diameter which is 5-150 μm on average of all grains (see for example Zogg, Martin: Einführung in die Mechanische Verfahrenstechnik, 3rd, revised Edition Stuttgart: Teubner, 1993 ISBN 3-519-16319-5, https://de.wikipedia.org/wiki/Siebanalyse, found on 1 Nov. 2018, or Lexikon Produktionstechnik Verfahrenstechnik/ed. Heinz M. Hiersig, Düsseldorf: VDI-Verl., 1995, ISBN 3-18-401373-1, entries “Siebanalyse” and “Sieben”).

Depending on the manner in which the melt is atomised in work step b) and how the additive manufacturing process is carried out, a loss of N can also occur due to the lower nitrogen solubility of metal melts in the course of the production and processing of a metal powder according to the invention. The invention takes this into account in that the N content of the melt is set such that in each case there is so much N in the finished component that the positive influences of N on the properties of the component occur. A precise adjustment of the N content can be carried out by the N content of the melt being over-alloyed by 0.1-0.2 mass % N compared to the N target content of the component, which is typically in the range of 0.15-1.0 mass % N, in particular 0.2-0.7 mass % N.

Metal powders according to the invention can be produced particularly well by gas atomisation of the melt alloyed according to the invention. In this case, a gas inert to the melt is preferably used in order to avoid oxidation of the metal particles. In particular, if the solidification of the metal powder takes place by means of heat input, greater N losses can be avoided during the additive processing of the metal powder according to the invention by the processing being carried out under a protective gas atmosphere, for example consisting of N or argon (“Ar”).

Similarly, if the metal powder is to be produced by gas atomising, larger N losses can be avoided if N or Ar are used as atomising gas. Nitrogen has particularly proven its worth as a process gas in both additive manufacturing and gas atomisation, as its use counteracts the outgassing of nitrogen from the steel that is melted for a short time during atomising or additive manufacturing.

Recent developments have shown that metal powder according to the invention can also be produced from a steel melt alloyed according to the invention as an alternative to gas atomisation by conventional water atomising, which meets the requirements resulting from its further processing.

The mechanical properties of a component produced according to the invention can be improved by an optionally performed heat treatment (work step e)). For this purpose, the respective component can be held for an annealing duration of 5-120 minutes at a temperature of 1000-1250 ° C., wherein annealing durations of 10-30 min and annealing temperatures of 1100-1150° C. have proven to be particularly practical.

The processing of the metal powder according to the invention can take place in the additive manufacturing completed according to the invention with 3D printing devices known from the prior art and provided for this purpose. Thus, in additive manufacturing, the metal powder processed according to the invention can be solidified by means of heat input, in which in work step c.1) at least one first portion is subjected, in volume sections, to a time-limited heat input with subsequent cooling, so that the steel particles of the metal powder, which are present in the heated volume section and respectively adjoin one another, form a materially bonded connection and are solidified after cooling to the respective volume section of the component to be manufactured. Tests have shown that good work successes can be safely achieved if a laser beam is used as a heat source in work step c.1), which is directed at the volume section to be respectively heated with an energy density of 30-90 J/mm³.

Alternatively, however, it is also possible to carry out additive manufacturing as what is known as binder jetting, in which the powder particles are glued together by a suitable binder in order to form the solid component (see https://de.wikipedia.org/wiki/Binder_Jetting, found on 16 Jan. 2020).

According to the above explanations, a component according to the invention is also characterised in that it
is manufactured by an additive manufacturing process,
consists of, in mass %, 0.15-1.0% C, 0.15-1.0% N, 0.1-2.0% Si, 8-24% Mn, 5-21% Cr, 0.15-3.0% Mo, ≤5% Ni and as the remainder of iron and unavoidable impurities, and
has a structure consisting of more than 50 vol. % austenite, up to at most 49 vol. % ferrite and as the remainder of ferrite and other manufacture-related unavoidable structural constituents, wherein the proportion of unavoidable structural constituents in the structure of the component is at most 30 vol. %.

In the event that machine elements such as pump housings and comparably filigreely formed components for machines, vehicle bodies or vehicle chassis are to be manufactured from a metal powder according to the invention, it may be sufficient in many applications if the structure of the respectively produced component consists predominantly, i.e. in each case more than 50 vol. %, in particular more than 60 vol. % or at least 80 vol. % of austenite, while the remainder of the structure is taken up by ferrite and up to 30 vol. % of other unavoidable structural constituents. Other unavoidable constituents taking up to 30% by volume of the structure include chromium carbides, chromium nitrides and sigma phase. Preferably, the proportion of the other manufacture-related unavoidable constituents is limited to at most 20 vol. %, in particular at most 15 vol. % or, particularly preferably, up to 5 vol. % in order to achieve optimised mechanical properties of the component.

If the ferrite proportion in the structure of a component according to the invention is up to 15 vol. %, in particular up to 10 vol. %, this can contribute to improved toughness properties with consistently high strength values. This combination of properties may be of particular interest if a component according to the invention is exposed to high alternating loads in practical use or should be able to absorb high dynamic forces, as is the case with crash-relevant components of vehicle bodies or chassis.

If, on the other hand, a component provided according to the invention is to be used for medical purposes, it has proven to be particularly advantageous if the austenite proportion of the structure is at least 95 vol. %, in particular at least 98 vol. %, so that the component is safely amagnetic.

Components according to the invention regularly have a tensile strength Rm of at least 650 MPa and a yield strength Rp of at least 650 MPa in the non-heat-treated state. In addition, in this state, they achieve a notch impact energy of at least 30 J and a notch impact strength of at least 50 J/cm3, wherein in practice a notch impact energy of at least 40 J and a notch impact strength of at least 60 J/cm3 are regularly achieved. The surface hardness measured on the free surface of the component according to the invention in the unhardened state is typically at least 200 HV, in particular at least 250 HV. The elongation at break A5.65 of components according to the invention in the non-heat-treated state is regularly at least 15%.

As already mentioned, the mechanical properties of a component produced according to the invention can be further increased by the optionally provided heat treatment. In a notch impact test, they achieve a notch impact energy of at least 100 J and a notch impact strength of at least 120 J/cm³. The surface hardness measured on the free surface of the component according to the invention is typically at least 200 HV without edge layer hardening.

In this context, it is known that the mechanical properties of components manufactured by an additive manufacturing process of the type in question have an anisotropy. The limit values indicated above are therefore in each case those values that must be complied with by the relevant mechanical properties, regardless of whether they are determined in the horizontal or vertical direction of the respective component. The “vertical” construction direction refers to the extension of the component in the direction in which the layer-by-layer construction of the component takes place during additive manufacturing, whereas the “horizontal” construction direction refers to the extension of the component which is aligned transverse thereto.

Due to the composition of the steel particles of a metal powder according to the invention, it is possible to subject the alloys presented according to the invention to a surface hardening which is connected to the 3D printing process and carried out in a conventional manner, which can in particular be effected by plasma nitriding. The high chromium content in the alloys leads to the formation of a chromium carbide or chromium nitride layer and the associated increase in hardness in near-surface regions. These properties are in particular very advantageous for components that are subject to dynamic load or wear.

In a variant of the metal powder according to the invention which is particularly suitable for the manufacture of machine elements in practice, its steel particles consist of, in mass %, 0.35-0.45% C, 0.55-0.65% N, 0.2-0.3% Si, 20.0-21.0% Mn, 17.5-18.5% Cr, 1.9-2.1% Mo, up to 1.0% Ni and as the remainder of iron and up to 1.0 mass % of unavoidable impurities, wherein the impurities includes those which per se have undesired contents of ≤0.02% P, ≤0.02% S, ≤0.05% Nb, ≤0.05% W, ≤0.05% V, ≤0.1% O, ≤0.01% B and ≤0.1% Al.

A variant of the steel of the steel particles of a metal powder according to the invention which is particularly suitable in practice for the manufacture of components for use on or in the human or animal body differs from the alloy indicated in the preceding paragraph only in that the Ni content is limited to at most 0.1 mass %, preferably less than 0.1 mass %.

### DETAILED DESCRIPTION OF THE INVENTION

The invention is explained in greater detail below using exemplary embodiments.

In order to test the properties of metal powders according to the invention and components manufactured from them by additive manufacturing, nine melts M1-M9 were produced in a first series of tests, the composition of which is indicated in Table 1.

Due to their minimised Ni content, the melts M1-M9 are suitable for the production of the steel particles of metal powders used to manufacture components intended for use on human or animal bodies.

The melts M1-M9 have been gas-atomised into steel particles in a conventional manner with an atomising device established in the prior art for this purpose. Nitrogen was used as an atomising gas.

From the steel particles obtained by the atomising, the particles whose average grain size was 10 μm to 53 μm were selected by sieving and air separation. The flow rate of the thus selected steel particles determined in accordance with DIN EN ISO 4490 was 18 s/50 g.

In a further step, the metal powders produced were processed using a conventional 3D printing device (3D printer of type M290, see https://www.eos.info/eos-m-290, accessed on 19 Dec. 2019). The metal powders could be processed without any problems and the components produced showed a dense structure, free of pores or cracks. Overall, it was demonstrated that reliable components could be produced from the metal powders in an energy density range of 30-90 J/mm³.

Argon was used as the process gas in some of the 3D printing tests and nitrogen in others. Both process gases produced consistently good results.

A phase analysis of the printed components using X-ray diffractometry revealed that there were no chromium carbides or other precipitates that could negatively influence the corrosion properties.

The printed components each had a completely austenitic structure (austenite proportion ≥99 vol. %).

The tensile strengths Rm, the yield strengths Rp, the notch impact energy, the notch impact strengths and the Vickers hardnesses of the printed components were also conventionally determined in accordance with standards.

Table 2 shows the regions in which the relevant characteristic values were found to have been determined in the horizontal construction direction of the components for the components that were printed from metal powders produced from the melts M1-M9.

Table 3 shows the regions in which the relevant characteristic values were determined in the vertical construction direction of the components for the components that were printed from metal powders produced from the melts M1-M9.

In addition, Tables 2 and 3 list the corresponding characteristic values, where available, of the reference material 316L known from the specialist literature (see https://www.fabb-it.de/files/datenblaetter/edelstahl.pdf, found on 16 Jan. 2020), whose composition is also indicated in Table 1.

The tests show that the mechanical properties of the non-heat-treated components printed from the metal powders according to the invention are not only superior to the mechanical properties of the components produced from the conventional material 316L, but also that high C and N contents lead to significantly improved mechanical properties of the components produced according to the invention.

For a second series of tests, another melt was melted and also atomised into steel particles in the manner explained above for the melts M1-M9. The composition M10 of the steel particles obtained is indicated in Table 4. From the steel particles, those whose average grain diameter was 10-53 μm were selected by sieving. The flow rate of the metal powder thus obtained was 16.8 s/50 gr with a bulk density of 4.23 g/cm³.

Twenty components were printed from the metal powder formed by the steel particles using the aforementioned M290 3D printer. Nitrogen was used as a protective gas. The components were printed with a layer thickness of 40 μm per layer.

The density, Vickers hardness HV, notch impact energy, yield strength Rp, tensile strength Rm, elongation at break A5.65 were tested on the twenty components in the non-heat-treated state in accordance with standards in the vertical construction direction. The mean values of the results of these examinations are summarised in Table 5 and compared with the corresponding characteristic values of a component printed from the conventional steel 316L, which were taken from the aforementioned citation. Again, a clear superiority of the material provided and processed according to the invention is demonstrated here.

In addition, the composition and the structure of the components printed from the metal powder formed by the steel particles M10 according to the invention have been examined. This showed that a significant loss of Mn and N occurred due to the 3D printing process used. The average Mn content of the components was around 8% lower than the Mn content of the steel particles of the metal powder. Similarly, the N content of the components declined on average by about 12% during the 3D printing process. However, the Mn and N content remaining in the components was sufficient to ensure the characteristics of a completely austenitic structure (austenite proportion >99 vol. %) in the components.

Finally, a corrosion test according to SEP 1877 method II was carried out on one of the components printed from metal powder with the steel particles composed according to the invention corresponding to the alloy M10 and for comparison on a component printed from a conventional metal powder, the steel particles of which consisted of the steel 316L. This test is used to test the resistance of highly-alloyed corrosion-resistant materials to intergranular corrosion. Both components passed the test and were therefore resistant to intergranular corrosion.

Furthermore, the components printed from the metal powder according to the invention and the components printed from the steel 316L used for comparison were subjected to a pitting corrosion test in accordance with ASTM G48, method E. Here too, it was found that the components produced from the metal powder according to the invention had a resistance to pitting corrosion which was at least equal to the conventional metal powders that were printed and used for comparison.

Finally, the components printed from the metal powder according to the invention with the steel particles composed according to the alloy M10 were subjected to a heat treatment in which they were heated for an annealing duration of 30 minutes to a temperature of 1125° C. and then quenched with water. The notch impact energy has been determined in a standardised manner on the thus heat-treated components. This averaged 129±2 J, which corresponds to approximately 2.4 times the notch impact energy of 52±3 J achieved on average by the non-heat-treated state in the standard notch impact test.

TABLE 1
Information in mass %, the remainder being Fe
and unavoidable impurities

| Powder | C + N | C | N | Si | Mn | Cr | Mo | Ni |
|---|---|---|---|---|---|---|---|---|
| M1 | 0.6 | 0.3 | 0.3 | 0.1 | 15.0 | 14 | 0.5 | ≤0.1 |
| M2 | 0.7 | 0.3 | 0.4 | 0.2 | 16.0 | 15 | 1.0 | ≤0.1 |
| M3 | 0.8 | 0.3 | 0.5 | 0.3 | 17.0 | 16 | 1.5 | ≤0.1 |
| M4 | 0.9 | 0.4 | 0.5 | 0.4 | 18.0 | 17 | 2.0 | ≤0.1 |
| M5 | 1.0 | 0.4 | 0.6 | 0.5 | 19.0 | 18 | 2.5 | ≤0.1 |
| M6 | 1.1 | 0.5 | 0.6 | 0.6 | 20.0 | 19 | 3.0 | ≤0.1 |
| M7 | 1.2 | 0.5 | 0.7 | 0.1 | 21.0 | 20 | 3.0 | ≤0.1 |
| M8 | 1.3 | 0.6 | 0.7 | 0.15 | 22.0 | 21 | 3.0 | ≤0.1 |
| M9 | 1.4 | 0.7 | 0.7 | 0.2 | 23.0 | 21 | 3.0 | ≤0.1 |
| 316L | — | <0.03 | <0.1 | <0.75 | <2.0 | 18 | 2.7 | 14 |

TABLE 2

| | | Notch | Notch | | |
|---|---|---|---|---|---|
| | | impact | impact | | |
| | Hardness | energy | strength | Rp | Rm |
| Steel | [HV] | [J] | [J/cm³] | [MPa] | [MPa] |
| M1 . . . M9 | 250-450 | 30-120 | 50-150 | 650-1100 | 650-1300 |
| 316L | 162 | n.d. | n.d. | 530 ± 60 | 640 ± 50 |

* n.d. = not determined

TABLE 3

| | | Notch | Notch | | |
|---|---|---|---|---|---|
| | | impact | impact | | |
| | Hardness | energy | strength | Rp | Rm |
| Steel | [HV] | [J] | [J/cm³] | [MPa] | [MPa] |
| M1 . . . M9 | 250-450 | 30-120 | 50-150 | 650-1200 | 650-1300 |
| 316L | 162 | 166 ± 12 | 132 | 470 ± 90 | 540 ± 55 |

TABLE 4
Alloy M10, information in mass %, remainder being Fe and impurities

| | C + N | C | N | Si | Mn | Cr | Mo | Ni |
|---|---|---|---|---|---|---|---|---|
| Powder | 0.942 | 0.39 | 0.552 | 0.22 | 18.4 | 19.2 | 2.25 | 0.1 |
| Component | 0.861 | 0.38 | 0.481 | 0.25 | 16.9 | 19.2 | 2.35 | 0.1 |

TABLE 5

| | | | Notch | | | |
|---|---|---|---|---|---|---|
| | | | impact | | | |
| | Density | Hardness | energy | Rp | Rm | A 5.65 |
| Steel | [g/cm³] | [HV] | [J] | [MPa] | [MPa] | [%] |
| M10 | 7.78 | 350 ± 4 | 52 ± 3 | 915 ± 11 | 1120 ± 9 | 30 ± 2 |
| 316L | 7.92 | 162 | 50 ± 10 | 470 ± 90 | 540 ± 55 | 45 ± 1 |

1. A metal powder for use in an additive manufacturing process and consisting of steel particles which
have an average diameter of 5-150 μm and
consist of, in mass %,
C: 0.15-1.0%,
N: 0.15-1.0%,
Si: 0.1-2.0%,
Mn: 10-25%,
Cr: 5-21%,
Mo: 0.1-3.0%,
Ni: ≤5%,
with the remainder being iron and unavoidable impurities,
wherein the metal powder has a flow rate determined in accordance with DIN EN ISO 4490 of less than 30 sec/50 g.

2. The metal powder according to claim 1, wherein the Mn content of its steel particles is at least 15 mass %.

3. The metal powder according to claim 1, wherein the Cr content of its steel particles is at least 14 mass %.

4. The metal powder according to claim 1 wherein the Ni content of its steel particles is at most 0.1 mass %.

5. The metal powder according to claim 1 wherein the total of the contents of C and N of its steel particles is 0.6-1.5 mass %.

6. A method of additive manufacturing of components for use in or on the human or animal body including the step of using the metal powder as set forth in claim 1.

7. A method for manufacturing a steel component, comprising the following steps:
a) melting a steel melt, which consists of, in mass %,
C: 0.15-1.0%,
N: 0.15-1.0%,
Si: 0.1-2.0%,
Cr: 5-21%,
Mo: 0.1-3.0%,
Ni: ≤5%,
and of Mn
and as the remainder of iron and manufacture-related unavoidable impurities,
wherein the Mn content of the melt is 0.5-5% higher than the respective Mn target content % Mn_Z of the component to be manufactured, for which the following applies: 8%≤Mn_Z≤24%.
b) atomising the melt melted in work step a) into a metal powder, wherein the steel particles obtained with an average grain size of 5-150 μm are selected for further processing;
c) manufacturing the component using an additive manufacturing process in which
c.1) at least one solidified volume section of the component to be manufactured is produced from at least one portion of the metal powder;
c.2) if necessary, a further portion of the metal powder is applied to the volume section solidified in work step c.1
and
c.3) if necessary, work steps c.1 and c.2 are repeated until the component to be manufactured is additively formed in a completely finished manner;
d) optional machining to shape the components;
e) optional final heat treatment of the component obtained;
f) optional mechanical or thermochemical edge layer treatment of the component.

8. The method according to claim 7, wherein the component is held at a temperature of 1000-1250° C. for a duration of 5 min-120 min during the optional heat treatment (work step e)) carried out.

9. The method according to claim 7, wherein the atomisation of the melt in work step b) is carried out as gas atomisation.

10. The method according to claim 7, wherein in work step c.1) a laser beam is used as a heat source, which is directed at the volume section to be heated in each case with an energy density of 20-110 J/mm³.

11. A component that
is manufactured by an additive manufacturing process,
consists of, in mass %, 0.15-1.0% C, 0.15-1.0% N, 0.1-2.0% Si, 8-24% Mn, 5-21% Cr, 0.15-3.0% Mo, ≤5% Ni and as the remainder of iron and unavoidable impurities, and
has a structure consisting of more than 50 vol. % austenite, up to at most 49 vol. % ferrite and as the remainder of ferrite and other manufacture-related unavoidable structural constituents, wherein the proportion of unavoidable structural constituents in the structure of the component is at most 30 vol. %.

12. The component according to claim 11, wherein it has a tensile strength Rm of at least 650 MPa and a yield strength Rp of at least 650 MPa in the non-heat-treated state and achieves a notch impact energy of at least 30 J and a notch impact strength of at least 50 J/cm³ in the notch impact test.

13. The component according to claim 12, wherein its surface hardness is at least 250 HV.

14. The component according to claim 11, wherein the heat-treated state in the notch impact test it achieves a notch impact energy of at least 100 J and a notch impact strength of at least 120 J/cm³.

15. The component according to claim 14, wherein its surface hardness is at least 200 HV.
